(19) United States
(12) Patent Application Publication
(10) Pub. No.: US 2006/0168955 A1
(43) Pub. Date: Aug. 3, 2006

(54) APPARATUS FOR HYDRAULICALLY ENERGIZING DOWN HOLE MECHANICAL SYSTEMS

(75) Inventors: COLIN LONGFIELD, HOUSTON, TX (US); JEAN-MARC FOLLINI, HOUSTON, TX (US)

Correspondence Address: SCHLUMBERGER OILFIELD SERVICES, 200 GILLINGHAM LANE, MD 200-9, SUGAR LAND, TX, 77478, US

(73) Assignee: SCHLUMBERGER TECHNOLOGY CORPORATION, SUGAR LAND (US)

(21) Appl. No.: 10/906,126

(22) Filed: Feb. 3, 2005

(51) Int. Cl. F16D 31/02

(52) U.S. Cl. 60/473

(57) ABSTRACT

A pumping system for a downhole tool positionable in a wellbore penetrating a subterranean formation. The pumping system includes an actuator, a fluid movement source and a passive flow distribution block. The actuator has a body slidably positionable in a vessel. The body defines a first chamber and a second chamber in the vessel. The fluid movement source has at least one port for selectively moving fluid in at least two directions. The passive flow distribution block is adapted to selectively divert fluid from the fluid movement source to one of the first and second chambers whereby the body is selectively reciprocated.

### BACKGROUND OF THE INVENTION

1. Field of the Invention

The present invention relates to fluid flow control, and more particularly to down hole systems for drawing fluid, such as hydraulic fluid, formation fluid and/or borehole fluid into and/or through a downhole tool.

2. Background of the Related Art

Wellbores are typically drilled into the earth to locate and produce valuable hydrocarbons. Downhole tools are often lowered into the wellbore to perform various tests and/or take samples in order to identify the desired hydrocarbons and/or wellbore conditions. Historically, downhole tools have probes capable of establishing fluid communication between the formation and the downhole tool. Such tools use pressure differentials to cause fluid to flow from the formation and into the downhole tool. More recently, wireline tools have been provided with pumps to assist in drawing the fluid into the downhole tool.

FIGS. 1 and 2 illustrate a prior art wireline downhole tool A which can be suspended from a rig 5 by a wireline 6 and lowered into a well bore 7 for the purpose of evaluating one or more surrounding subsurface formations 1. Details relating to the downhole tool A are described in U.S. Pat. Nos. 4,860,581 and 4,936,139, both assigned to Schlumberger, the entire contents of which are hereby incorporated by reference. The downhole tool A has a hydraulic power module C, a packer module P, and probe modules E and F. The hydraulic power module C includes a pump 16, a reservoir 18, and a motor 20 to control the operation of the pump 16. A low oil switch 22 also forms part of the control system and is used in regulating the operation of the pump 16.

A hydraulic fluid line 24 is connected to the discharge of the pump 16 and runs through the hydraulic power module C and into adjacent modules for use as a hydraulic power source. In the embodiment shown in FIG. 1, the hydraulic fluid line 24 extends through the hydraulic power module C into the probe modules E and/or F depending upon which configuration is used. The hydraulic loop is closed by virtue of a hydraulic fluid return line 26, which in FIG. 1 extends from the probe module E back to the hydraulic power module C where it terminates at the reservoir 18.

The downhole tool A further includes a pump-out module M, seen in FIG. 2, which can be used to dispose of unwanted samples by virtue of pumping fluid through a flow line 54 into the borehole, or may be used to pump fluids from the borehole into the flow line 54 to inflate straddle packers 28 and 30 (FIG. 1). Furthermore, the pump-out module M may be used to draw formation fluid from the borehole via the probe module E or F, and then pump the formation fluid into a sample chamber module S against a buffer fluid therein. In other words, the pump-out module is useful for pumping fluids into, out of, and through the downhole tool A.

A piston pump 92, energized by hydraulic fluid from a pump 91, can be aligned in various configurations, e.g., to draw from the flow line 54 and dispose of the unwanted sample though a flow line 95, or it may be aligned to pump fluid from the borehole (via the flow line 95) to the flow line 54. The pump-out module M can also be configured where the flow line 95 connects to the flow line 54 such that fluid may be drawn from the downstream portion of the flow line 54 and pumped upstream or vice versa. The pump-out module M has the necessary control devices to regulate the piston pump 92 and align the flow line 54 with the flow line 95 to accomplish the pump-out procedure.

With reference now to FIGS. 3A-B and 4A-B, a particular embodiment of the pump-out module M (FIG. 2) may use four reversible mud check valves 390 (also referred to as CMV1-CMV4) to direct the flow of the fluid being pumped is depicted. The reversible mud check valves 390 are similar in construction. Thus, similar components will only be labeled on the reversible valve CMV2 in FIG. 3A and CMV1 and CMV3 in FIG. 3B for purposes of clarity. These reversible mud check valves 390 allow the pump-out module M to pump either up or down (assuming a vertical borehole section) or in or out (depending on the tool configuration), and utilize a spring-loaded ceramic ball 391 that seals alternately on one of two 0-ring seats, an upper seat 393a, and a lower seat 393b to allow fluid flow in only one direction. The O-ring seats 393a and 393b are mounted in a sliding piston-cylinder 394, also called a check valve slide or simply a piston slide.

More particularly, FIGS. 3A-B show the respective first and second strokes of the two-stroke operation of a piston pump 392 with the pump-out module M configured to “pump-in” mode, where fluid is drawn into the pump-out module M through a port 346 (e.g., a probe) for communication via a flow line 354. Thus, solenoids S1, S2 are energized in FIGS. 3A-B so as to direct hydraulic fluid pressure to shift the piston slides 394 of check valves CMV1 and CMV2 upwardly and shift the piston slides 394 of check valves CMV3 and CMV4 downwardly. This results in an upper springs 395a of check valves CMV1 and CMV2 biasing the respective ceramic balls 391 against the lower seats 393b, and lower springs 395b of check valves CMV3 and CMV4 biasing the respective ceramic balls 391 against the upper seats 393a. This allows fluid to flow upwardly through valve CMV2 and downwardly through valve CMV4 (both shown slightly opened) under movement of a pump piston 392p to the left (the first stroke), as indicated by the directional arrows of FIG. 3A. Similarly, this allows fluid to flow upwardly through valve CMV1 and downwardly through valve CMV3 (both shown slightly opened) under movement of the pump piston 392p to the right (the second stroke), as indicated by the directional arrows of FIG. 3B. Sufficient fluid-flowing pressure (e.g., >50 psig) is needed to overcome the respective spring-biasing forces. Solenoid S3 is provided to selectively move the pump piston 392p from the position in FIG. 3A to the position in FIG. 3B and back. Solenoid S3 is also preferably linked to the solenoids S1 and S2 to synchronize the timing therebetween.

FIGS. 4A-B, on the other hand, show the respective first and second strokes of the two-stroke operation of the piston pump 392 with the pump-out module M configured to “pump-out” mode, where fluid is discharged from the flow line 354 through the port 346 into the borehole. Thus, the solenoids S1, S2 have been de-energized in FIGS. 4A-B so as to direct hydraulic pressure to shift the piston slides 394 of check valves CMV1 and CMV2 downwardly and shift the piston slides 394 of check valves CMV3 and CMV4 upwardly. This results in the lower springs 395b of check valves CMV1 and CMV2 biasing the respective ceramic balls 391 against the upper seats 393a, and the upper springs 395a of check valves CMV3 and CMV4 biasing the respective ceramic balls 391 against the lower seats 393b. This allows fluid to flow downwardly through valve CMV1 and upwardly through valve CMV3 (both shown slightly opened) under movement of the pump piston 392p to the left (the first stroke), as indicated by the directional arrows of FIG. 4A. Similarly, this allows fluid to flow downwardly through valve CMV2 and upwardly through valve CMV4 (both shown slightly opened) under movement of the pump piston 392p to the right (the second stroke), as indicated by the directional arrows of FIG. 4B. Again, sufficient fluid-flowing pressure (e.g., >50 psig) is needed to overcome the respective spring-biasing forces.

In each of the FIGS. 3A-B and 4A-B, the check valves having no directional flow arrows are configured such that their respective ceramic balls 391 are subjected to fluid pressure assisting the spring-biasing forces, i.e., further compressing each ball against an o-ring seat to maintain a seal. Conversely, when the direction of fluid flow opposes the spring-biasing forces (and overcomes them), a gap is opened between the ball and the seat so as to permit the fluid flow indicated by the directional arrows. The valves open just enough to balance the pressure differential across the opening with the biasing forces provided by the respective springs.

The pump-out module M above illustrates one technique used to draw fluid from the formation and into a downhole tool. Despite such advances in pumping technology, there remains a need for a system that reduces costs and increases the reliability of the down hole tool, even in harsh wellbore conditions. It is desirable that such a system be capable of operating using a passive valve system and/or eliminating the need to use electrically operated solenoid valves. It is further desirable that such a system be adaptable for use in a downhole drilling tool. It is to such an improved down hole pumping system that the present invention is directed.

### SUMMARY OF THE INVENTION

The needs identified above, as well as other shortcomings in the art, are addressed by various aspects of the present invention. In one aspect, the present invention is directed to a pumping system for a downhole tool positionable in a wellbore penetrating a subterranean formation. The pumping system includes an actuator, a fluid movement source and a passive flow distribution block. The actuator has a body slidably positionable in a vessel. The body defines a first chamber and a second chamber in the vessel. The fluid movement source has at least one port for selectively moving fluid in at least two directions. The passive flow distribution block is adapted to selectively divert fluid from the fluid movement source to one of the first and second chambers whereby the body is selectively reciprocated.

The actuator can be used for any application where a movable piston can be used, such as a hydraulic piston, a pre-test piston, or a reciprocating pump. For example, the actuator can be used as a hydraulic piston for driving or moving the probe device, or the actuator can be used as a pump for inflating or deflating a packer with borehole fluid.

The fluid movement source can direct fluid in a first direction such that the pressure at one port of the fluid movement source is lower than the pressure at another port of the fluid movement source. The passive flow distribution block can include a check valve and a reservoir with the check valve permitting fluid movement from the reservoir to the one port having the lower pressure of the fluid movement source. The passive flow distribution block can also include a check valve positioned between the reservoir and the port having the higher pressure so as to block the flow of fluid from the port having the higher pressure to the reservoir.

In another aspect, the passive flow distribution block further includes a pilot check valve positioned between the reservoir and the second chamber of the actuator to permit fluid to flow from the second chamber of the actuator to the reservoir. The passive flow distribution block may also include another pilot check valve positioned between the reservoir and the first chamber of the actuator to prevent fluid from flowing from the first chamber of the actuator to the reservoir.

In yet another aspect, the passive flow distribution block is further provided with a check valve positioned between the reservoir and the actuator to prevent fluid from flowing from one side of the actuator to the reservoir.

In yet another aspect, the passive flow distribution block includes an inverse shuttle valve positioned in parallel with the actuator. [Para 22] The fluid movement source can be a bidirectional pump. In one aspect, the bidirectional pump includes two different single direction pumps, and a motor driving the two different single direction pumps. In another aspect, the bidirectional pump includes two separate motors with each motor driving respective single direction pumps.

In another aspect, the present invention is directed to a down hole tool positionable in a well bore having a wall and penetrating a subterranean formation. The formation has a fluid therein. The down hole tool is provided with a housing, an actuator, and a pumping system. The actuator has a body slidably positionable in a vessel. The body defines a first chamber and a second chamber in the vessel. The pumping system is provided with a fluid movement source having at least one port for selectively moving fluid in at least two directions. The passive flow distribution block is adapted to selectively divert fluid from the fluid movement source to one of the first and second chambers whereby the body is selectively reciprocated

The actuator, the fluid movement source and the passive flow distribution block can be any of the versions described above.

In another aspect, the present invention is directed to a method for moving a body of an actuator of a downhole tool in at least two directions. The body is slidably positionable in a vessel with the body defining a first chamber and a second chamber in the vessel. The downhole tool is positionable in a well bore having a wall and penetrating a subterranean formation. The formation has a fluid therein. The method comprises the steps of actuating a fluid movement source to move fluid in a first direction through a passive flow distribution block and into the first chamber of the actuator to cause the body of the actuator to move in one direction. The fluid movement source is then actuated to move fluid in a second direction through the passive flow distribution block and into the second chamber of the actuator to cause the body of the actuator to move in another direction.

### BRIEF DESCRIPTION OF THE DRAWINGS

So that the above recited features and advantages of the present invention can be understood in detail, a more particular description of the invention, briefly summarized above, may be had by reference to the embodiments thereof that are illustrated in the appended drawings. It is to be noted, however, that the appended drawings illustrate only typical embodiments of this invention and are therefore not to be considered limiting of its scope, for the invention may admit to other equally effective embodiments.

FIGS. 1-2 are schematic illustrations of a wireline-conveyed downhole tool with which the present invention may be used to advantage.

FIGS. 3A-B are schematic illustrations of a prior art fluid pumping module, showing in particular check valve settings and flow directions according to first and second respective strokes of a two-stroke piston “pump-in” cycle.

FIGS. 4A-B are schematic illustrations of the prior art fluid pumping module of FIGS. 3A-B, showing in particular check valve settings and flow directions according to first and second respective strokes of a two-stroke piston “pump-out” cycle.

FIG. 5A illustrates an inventive downhole tool having a down hole pumping system according to one embodiment of the present invention.

FIG. 5B is a schematic illustration of one version of the down hole tool depicted in FIG. 5A.

FIG. 6A is a schematic illustration of a down hole pumping system

FIG. 6B is a schematic illustration of an alternative to a reversible pump.

FIG. 6C is a schematic illustration of another alternative to a reversible pump.

FIG. 7 is a schematic illustration of one version of an actuator for the down hole pumping system having a pre-test piston performing work on a flowline connected to a formation through a probe or packer.

FIG. 8 is a schematic illustration of another version of an actuator for the down hole pumping system having a reciprocating piston pump moving borehole fluid.

FIGS. 9A-B are schematic illustrations of one version of a passive flow distribution block utilized in the down hole pumping system.

FIGS. 10A-B are schematic illustrations of another version of a passive flow distribution block utilized in the down hole pumping system.

FIG. 11 is a flow chart illustrating a method of using the down hole tool.

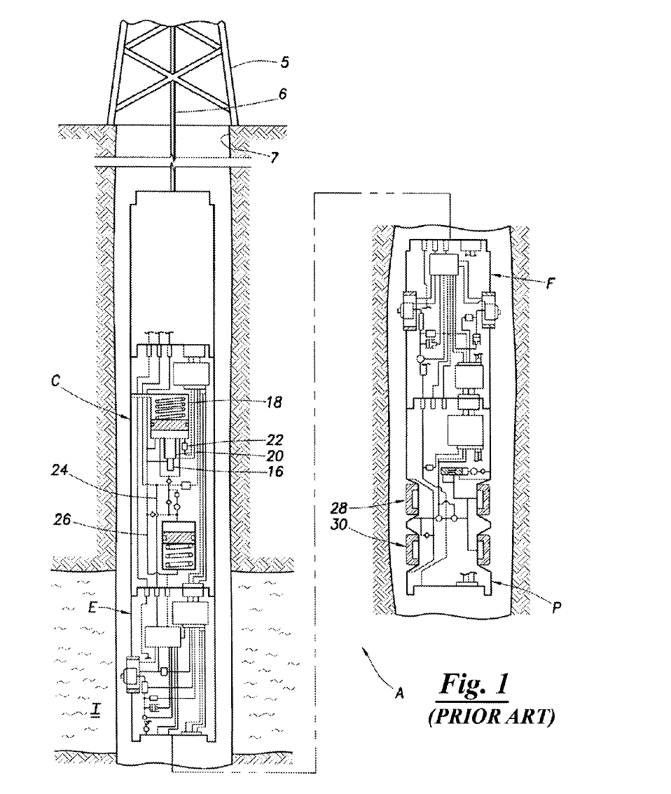

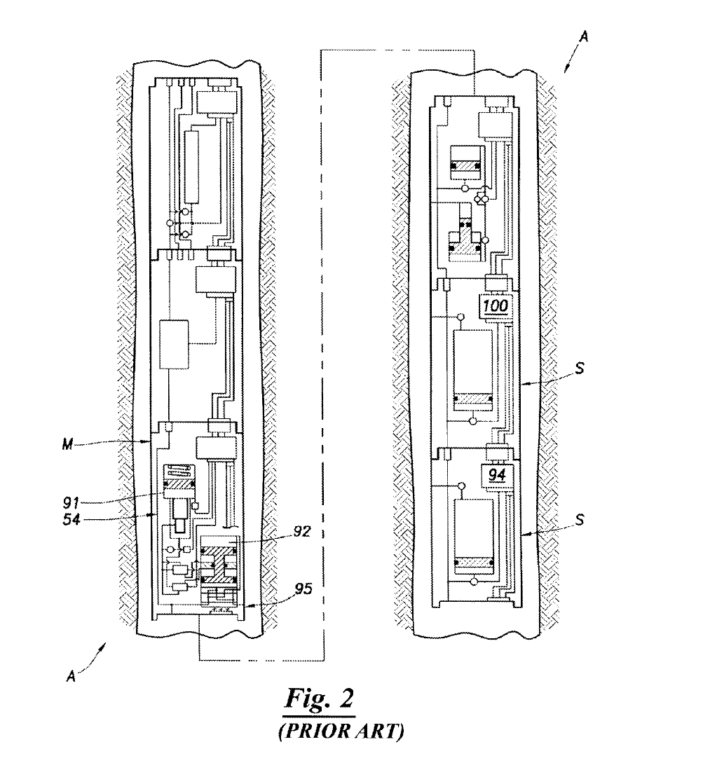

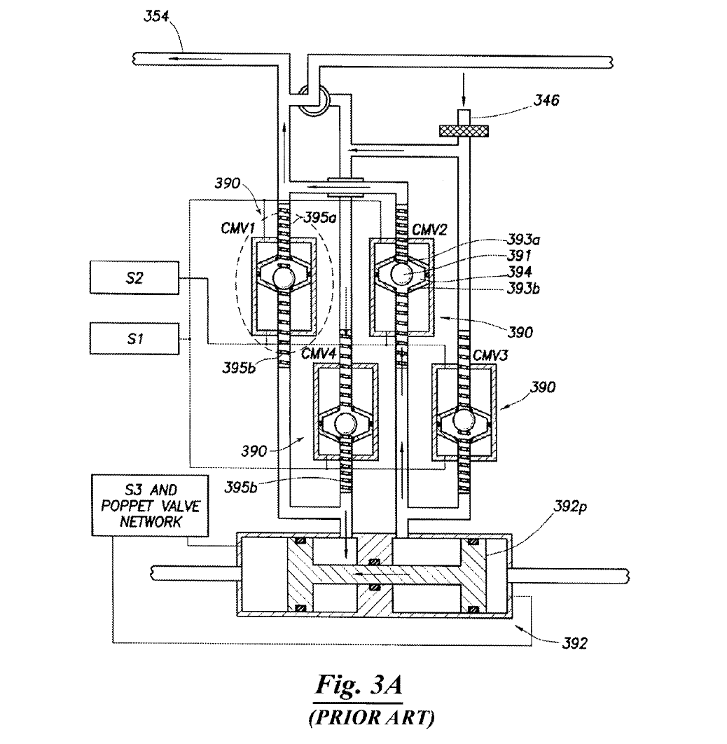

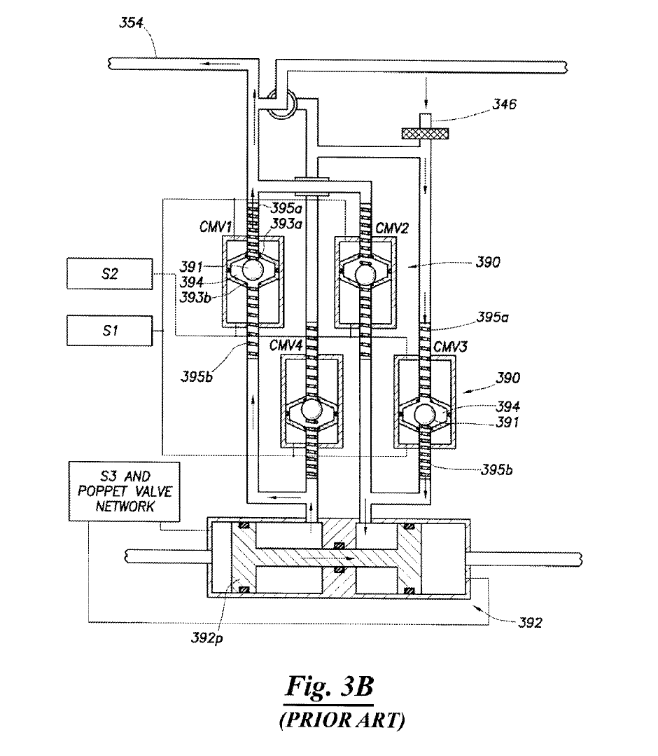

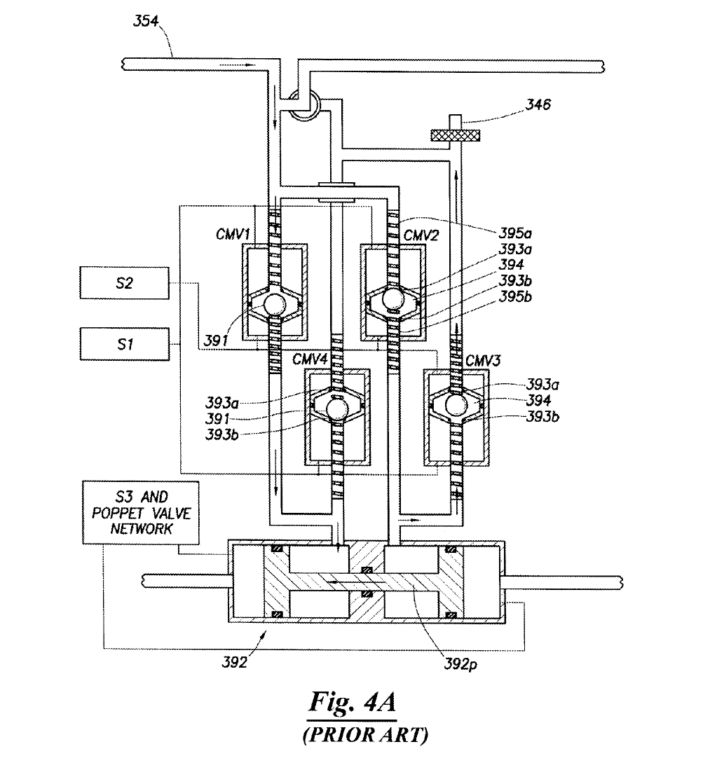

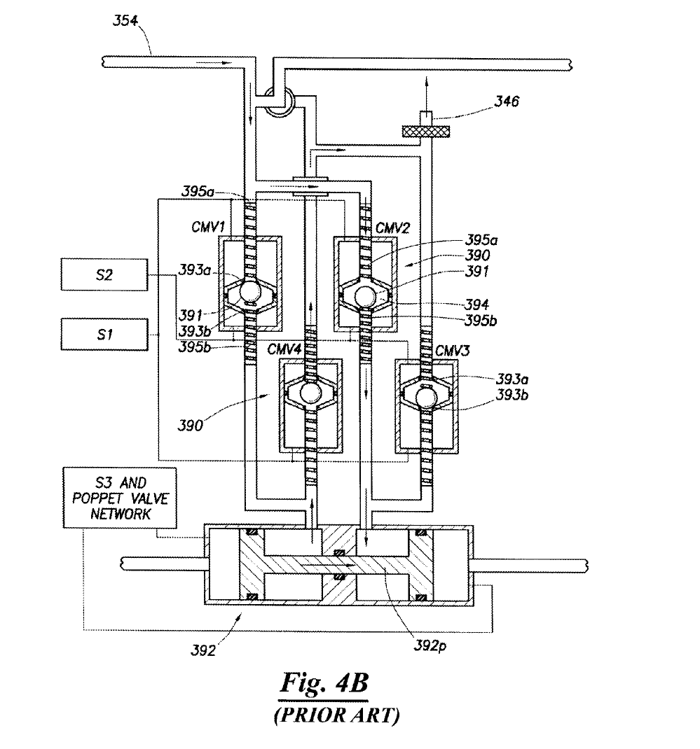

### DETAILED DESCRIPTION OF THE INVENTION

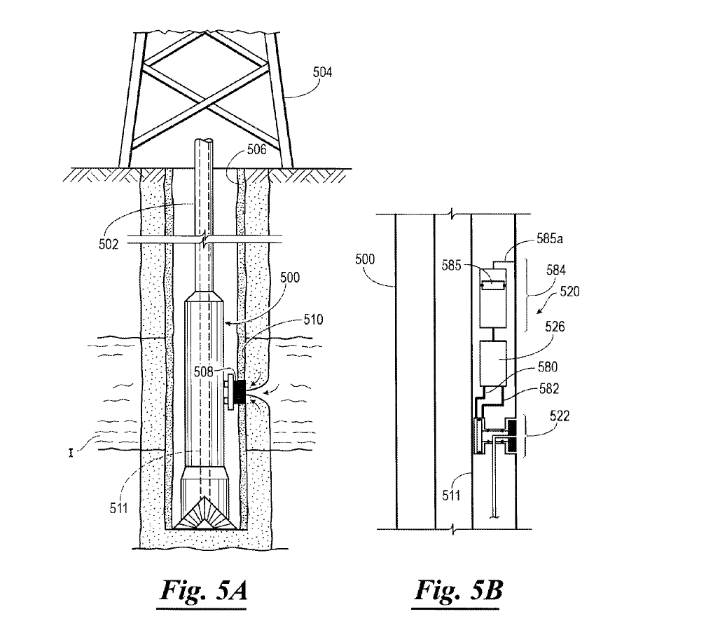

Referring now to the Figures and more particularly to FIG. 5A, shown therein and designated by a reference numeral 500 is an example of a down hole tool constructed in accordance with the present invention. The down hole tool 500 of FIG. 5A is a drilling tool, which can be conveyed among one or more (or itself may be) a measurement-while-drilling (MWD) drilling tool, a logging-while-drilling (LWD) drilling tool, or other drilling tool that is known to those skilled in the art. The down hole tool 500 is attached to a drill string 502 driven by a rig 504 to form a well bore 506. The down hole tool 500 includes a probe 508 adapted to seal with a wall 510 of the well bore 506 to draw fluid from the formation I into the down hole tool 500 as depicted by the arrows. When the down hole tool 500 is a drilling tool, the down hole tool 500 includes a bore 511 to permit drilling mud to be pumped through the drilling tool to remove cuttings away from the drill bit.

Although the down hole tool 500 is depicted as a drilling tool, it should be understood that the down hole tool 500 can be any tool deployed into the well bore 506 by means, such as a drill string, wireline, coiled tubing or other tool for performing wellbore operations.

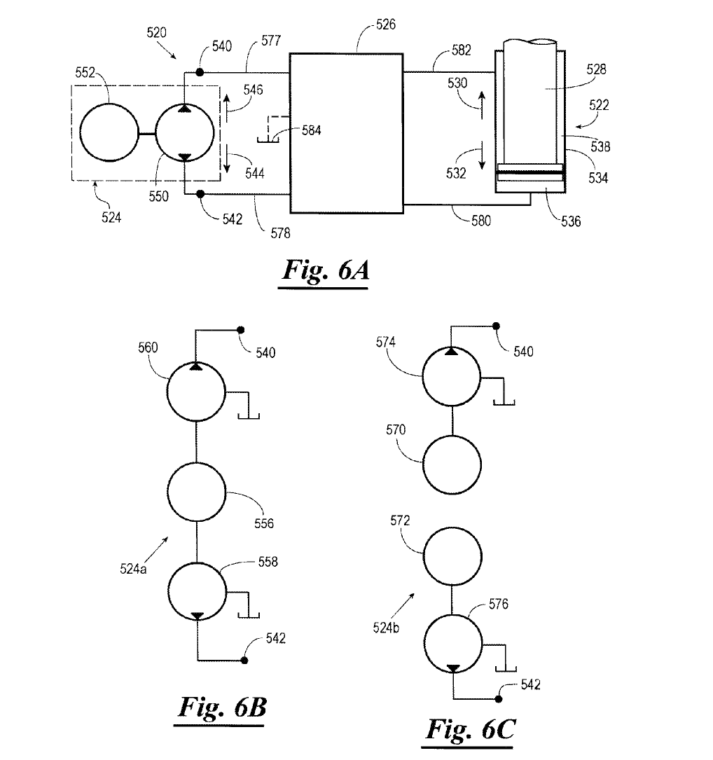

The down hole tool 500 is also provided with a pumping system 520, which is shown in more detail in FIGS. 5B and 6A. As shown in FIGS. 5B and 6A, the pumping system 520 drives one or more actuators 522 (only one of the actuators 522 are shown in FIGS. 5B and 6A for purposes of brevity). The pumping system 520 includes a fluid movement source 524 and a passive flow distribution block 526 typically cooperating to form a hydraulic pumping circuit. The actuator 522 has a body 528 capable of moving in at least two directions such as a first direction 530 and a second direction 532. The body 528 is disposed in or on a vessel 534 and is moved in the direction 530 and the direction 532 by fluid pressure. One skilled in the art will recognize that the body 528 can be any type of device moved by fluid pressure, such as a piston or pump. The body 528 and the vessel 534 can take a variety of forms so long as the body 528 can be moved relative to the vessel 534 due to fluid pressure. For example, the body 528 can be a piston or a valve and in this instance the body 528 and the vessel 534 are typically cylindrically shaped. In one version, the body 528 is slidably positionable in the vessel 534 with the body 528 defining a first chamber 536 and a second chamber 538 in the vessel 534.

The fluid movement source 524 moves fluid within the pumping system 520 in at least two directions. The fluid can be hydraulic fluid, borehole fluid, or formation fluid or combinations thereof. The fluid movement source 524 can be characterized as having at least two ports 540 and 542. In one mode, the fluid movement source 524 is adapted to move fluid within the pumping system 520 in a direction 544, and in this instance the port 540 serves as an inlet to the fluid movement source 524 and the port 542 serves as an outlet to the fluid movement source 524. In another mode, the fluid movement source 524 is adapted to move fluid within the pumping system 520 in a direction 546 generally opposite to the direction 544. In this mode, the port 542 serves as an inlet to the fluid movement source 524, and the port 540 serves as an outlet to the fluid movement source 524.

In the implementation depicted in FIG. 6A, the fluid movement source 524 includes a bi-directional pump 550 driven by a motor 552. However, it should be understood that the fluid movement source 524 can be implemented in any manner capable of moving fluid in at least two directions. For example an alternate fluid movement source 524a is shown in FIG. 6B. The fluid movement source 524a can include one motor 556 driving two different single direction pumps 558 and 560. In this example, when the motor 556 turns in one direction, e.g., clockwise, the motor 556 drives the pump 560, pumping fluid in the direction 546 toward the port 540, while the pump 558 is inactive. Likewise when the motor 556 turns in another direction, e.g., counter-clockwise, the motor 556 drives the pump 558 thereby pumping fluid in the direction 544 toward the port 542, while the pump 560 is inactive.

FIG. 6C illustrates another example of a fluid movement source 524b. In this example, the fluid movement source 524b includes two separate motors 570 and 572 with each motor 570 and 572 driving respective single direction pumps 574 and 576. As desired, each motor 570 and 572 can be turned independently to pump fluid in either the direction 544 or the direction 546.

Referring again to FIG. 6A, the passive flow distribution block 526 connects the fluid movement source 524 to the actuator 522 such that upon the fluid movement source 524 moving fluid in one direction (e.g. the direction 544), fluid is diverted into the first chamber 536 and the body 528 of the actuator 522 is moved in the direction 530, and upon the fluid movement source 524 moving fluid in another direction (e.g. the direction 546), fluid is diverted into the second chamber and the body 528 of the actuator 522 is moved in the direction 532. In general, the passive flow distribution block 526 is connected (1) to the fluid movement source 524 via flow lines 577 and 578, and (2) to the actuator 522 via flow lines 580 and 582.

The passive flow distribution block 526 also serves to compensate for differences in flow from the opposing sides of the body 528. That is, when rotating clockwise, for example, to move fluid in the direction 544 into the first chamber 536 to extend the body 528 in the direction 530, the pump 550 needs to provide much more fluid through the flow line 580 to extend the body 528 than it receives from the flow line 582 due to the difference in actuation area on either side of the body 528. When the body 528 is moving, the difference in actuation area translates into a difference in volume in the first and second chambers 536 and 538.

The passive flow distribution block 526 in this case works to supplement the fluid needed at the inlet (port 540) of the pump 550 by supplying additional fluid from a reservoir 584 to the flow line 577. A movable piston 585 is positioned within the reservoir 584. The reservoir 584 communicates with the well bore 506 via a flow line 585a. the piston 585 and the flow line 585a serve to equalize pressure between the local mud hydrostatic pressure within the well bore 506 and the pressure in the reservoir 584. It should be understood that the although the piston 585 is shown in FIG. 5B, other devices for equalizing the pressure can be used, such as a bellows or a membrane. The passive flow distribution block 526 takes this state because the flow line 578 has higher pressure than the flow line 577.

When retracting the body 528 (moving the body in the direction 532) the opposite is true. The pump 550 receives much more fluid from the first chamber 536 (extend side of the body 528) than it needs to supply to the second chamber 538 (retract side of the body 528) to translate the body 528. In this case, the passive flow distribution block 526 again changes state, based on the difference in pressure between the flow line 577 and the flow line 578 to allow the excess fluid to flow back to the reservoir 584.

The flow can be distributed such that the force acting on the body 528 is not diminished by pressure on the opposing side. The passive flow distribution block 526 can be designed such that it fully equalizes the opposing side of the body 528 to reservoir pressure so that the full force of the pump 550 is transmitted and not cancelled by trapped pressure on the opposing side.

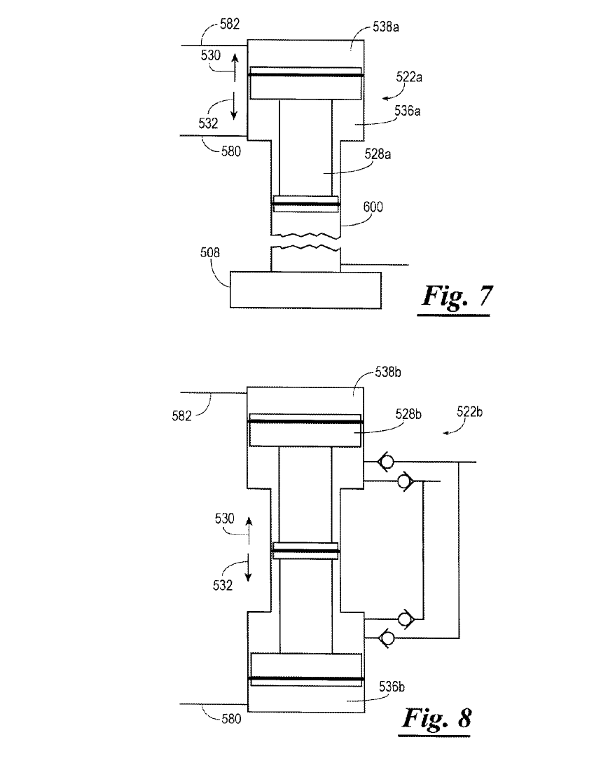

Referring to FIGS. 7 and 8, shown therein are two examples of proposed implementations of the pumping system 520. Shown in FIG. 7 is a schematic illustration of an example of an actuator 522a configured as a pre-test piston performing work on a flowline 600 connected to the formation I (FIG. 5A) through the probe or packer 508. The flow lines 580 and 582 can be connected on either side of a pre-test piston 528a to perform work on the flowline 600. In this regard, fluid is pumped into the flow line 580 into a first chamber 536a as shown and allowed to escape from a second chamber 538a to the flow line 582 thereby forcing the pre-test piston 528a in the direction 530. At the same time, the passive flow distribution block 526 allows the fluid on the other side of the pre-test piston 528a, to freely escape back to the reservoir 584 via the flow line 582. This expands the volume of fluid in connection with the formation I through the flow line 600 to draw fluid out of the formation I. A pre-test measurement would result when the flow-line is in sealed connection with a permeable formation. The pre-test piston 528a can be recycled by reversing the direction of the flow of the fluid within the flow lines 580 and 582.

Shown in FIG. 8 is a schematic illustration of an example of an actuator 522b configured as a reciprocating piston pump moving borehole fluid. The flow lines 580 and 582 of the pumping system 520 are connected to either side of the actuator 522b having a reciprocating piston 528b as shown. Fluid is directed into the flow line 580 to a first chamber 536b until the reciprocating piston 528b moves in the direction 530 to reach a stop (not shown). Simultaneously the excess fluid in a second chamber 538b is directed to the flow line 582 to escape back to the reservoir 584. Next the fluid movement source 524 is actuated to direct fluid into the flow line 582 to the second chamber 538b thereby driving the reciprocating piston 528b in the direction 532. This process is then repeated to force borehole fluid in and out of two inner chambers of the actuator 522b through the valving as shown.

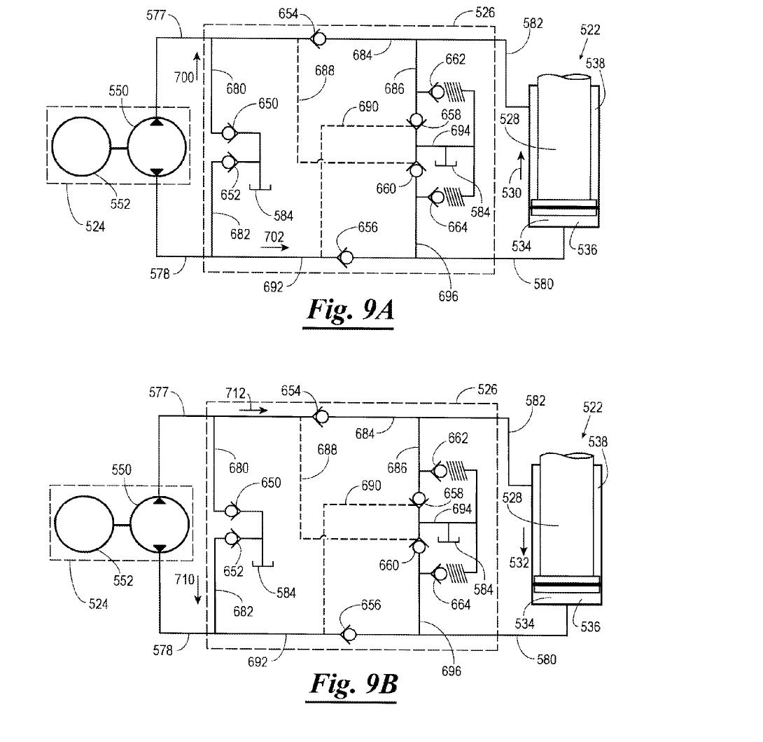

Shown in FIGS. 9A and 9B is one version of the passive flow distribution block 526 utilized in the pumping system 520. In general, the passive flow distribution block 526 includes a plurality of check valves 650, 652, 654, and 656, pilot check valves 658, and 660, relief valves 662 and 664 and flow lines 680, 682, 684, 686, 688, 690, 692 and 694 interconnecting the valves 650, 652, 654, 656, 658, 660, 662 and 664. In general, the valves 650, 652, 654, 656, 658, and 660, are automatically switched by pressure on either side of the fluid movement source 524.

FIG. 9A shows the passive flow distribution block 526 when the pump 550 of the fluid movement source 524 pressurizes the flow line 578 to extend the body 528 in the direction 530. The high pressure within the flow line 578 and the low pressure within the flow line 577 (1) opens the check valves 650, and 656 and the pilot check valve 658 and (2) closes or maintains the closure of the check valves 652, and 654, and the pilot check valve 660. Thus, fluid flows in a direction 700 through the flow lines 680 and 577 from the reservoir 584 to the pump 550. Fluid also flows in a direction 702 through the flow lines 578, 692 and 580 and the check valve 656 to extend the body 528 of the actuator 522. The high pressure within the flow line 692 is communicated to the pilot check valve 658 via the flow line 690 to open the pilot check valve 658 and thereby permit fluid to drain from the second chamber 538 into the reservoir 584 through the flow lines 582, 686 and 694.

When the direction of flow through the pump 550 is reversed as shown in FIG. 9B, the pump 550 directs fluid into the flow line 577 to move or retract the body 528 in the direction 532. The high pressure within the flow line 577 and the low pressure within the flow line 578 (1) opens the check valves 652, and 654, and the pilot check valve 660 and (2) closes or maintains the closure of the check valves 650, and 656 and the pilot check valve 658. Thus, fluid flows in a direction 710 through the flow lines 682 and 578 from the reservoir 584 to the pump 550. Fluid also flows in a direction 712 through the flow lines 577, 684 and 582 and the check valve 654 to retract the body 528 of the actuator 522. The high pressure within the flow line 684 is communicated to the pilot check valve 660 via the flow line 688 to open the pilot check valve 660 and thereby permit fluid to drain from the extend side of the body 528 into the reservoir 584 through the flow lines 580, 696 and 694.

Thus, fluid is drawn to the pump 550 from the reservoir 584 when necessary and excess fluid from the actuator 522 is provided to the reservoir 584. The check valves 654 and 656 isolate each side of the body 528 from leakage back through the pump 550. In addition, relief valves 662 and 664 are provided to prevent over pressurization of the pumping system 520 due to changes in hydrostatic pressure and/or temperature.

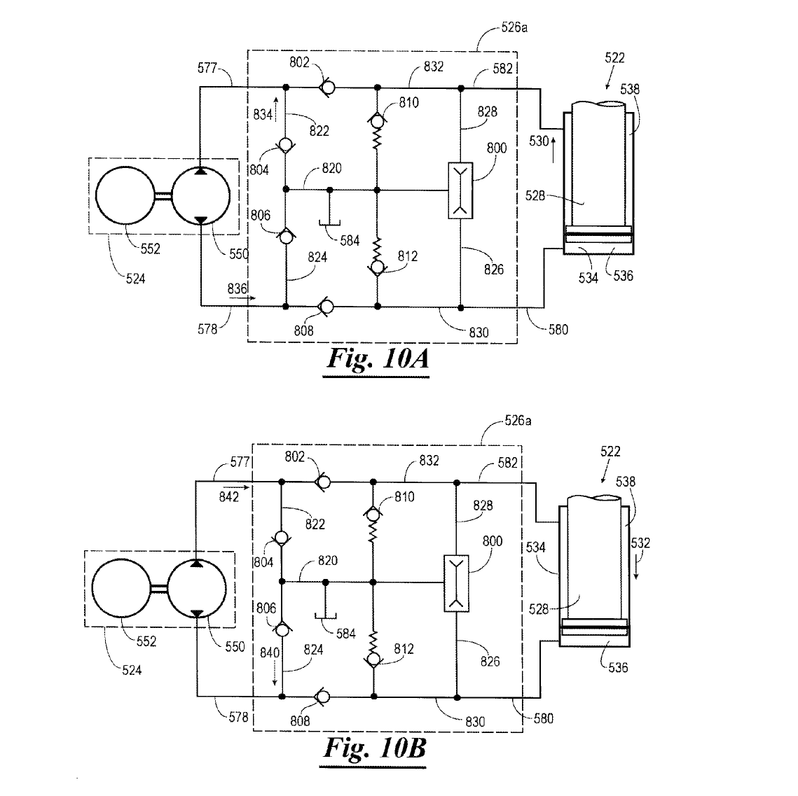

Another alternative for implementation of a passive flow distribution block 526a is depicted in FIGS. 10A and 10B. Although the passive flow distribution block 526a will be described in more detail below, it should be noted that the passive flow distribution block 526a is similar in construction and function to the passive flow distribution block 526a described above, except that the passive flow distribution block includes an inverse shuttle valve 800 which serves to replace the pilot check valves 658 and 660. In general, the inverse shuttle valve 800 will allow the flow of the lower pressure of the two lines on either side of the inverse shuttle valve 800.

The passive flow distribution block 526a also includes check valves 802, 804, 806 and 808, relief valves 810 and 812, and flow lines 820, 822, 824, 826, 828, 830 and 832. The inverse shuttle valve 800 allows fluid to flow from the flow line 580 to the flow line 820 and into the reservoir 584 when the body 528 is moving in the direction 532. Likewise, the inverse shuttle valve 800 allows fluid to flow from the flow line 582 to the flow line 820 and into the reservoir 584 when the body 528 is moving in the direction 530.

As shown in FIG. 10A, more particularly, when the fluid movement source 524 pressurizes the flow line 578 to divert fluid into the first chamber 536 to extend the body 528 in the direction 530, the high pressure within the flow line 578 and the low pressure within the flow line 577 (1) opens the check valves 804 and 808 and (2) closes or maintains the closure of the check valves 802 and 806. Thus, fluid flows in a direction 834 through the flow lines 820, 822 and 577 from the reservoir 584 to the pump 550. Fluid also flows in a direction 836 through the flow lines 578, 830 and 580 to extend the body 528 of the actuator 522. The inverse shuttle valve 800 opens to permit fluid to drain from the second chamber 538 (retract side of the body 528) into the reservoir 584 through the flow lines 582, 828 and 820.

When the direction of flow through the pump 550 is reversed as shown in FIG. 10B, the pump 550 directs fluid into the flow line 577 to move fluid into the second chamber 538 to move the body 528 in the direction 532. The high pressure within the flow line 577 and the low pressure within the flow line 578 (1) opens the check valves 802 and 806 and (2) closes or maintains the closure of the check valves 804 and 808. Thus, fluid flows in a direction 840 through the flow lines 820, 824 and 578 from the reservoir 584 to the pump 550. Fluid also flows in a direction 842 through the flow lines 577, 832 and 582 to retract the body 528 of the actuator 522. The inverse shuttle valve 800 opens to permit fluid to drain from the first chamber 536 of the body 528 into the reservoir 584 through the flow lines 580, 826 and 820.

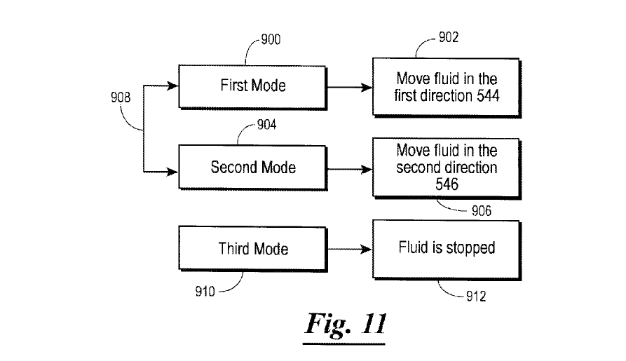

Shown in FIG. 11 is a flow chart illustrating one manner of using the pumping system 520. As shown in FIG. 11, the pumping system 520 can be used by actuating or switching the fluid movement source 524 to a first mode (as shown by a block 900) to move fluid within the pumping system 520 in the direction 544 (as shown by a block 902) to cause the body 528 of the actuator 522 to move in the direction 530. Then, the fluid movement source 524 is switched to a second mode (as shown by a block 904) to move fluid within the pumping system 520 in the direction 546 (as shown by a block 906)generally opposite to the direction 544. This causes the body 528 of the actuator 522 to move in the direction 532. The fluid movement source 524 can be sequentially switched between these two modes (as shown by a line 908) to cause the body 528 to reciprocate within the vessel 534. In a third mode (as shown by a block 910), the fluid movement source 524 is “turned off” or stopped so that fluid is not moved (as shown by a block 912). In the third mode, the body 528 is maintained at its current position.

Although the actuator 522 has been described as a hydraulic piston, a pre-test piston, or a reciprocating pump, it should be understood that the actuator 522 can be used for any application where a movable piston can be used. For example, the actuator 522 can be used as a hydraulic piston for driving or moving the probe device, or the actuator 522 can be used as a pump for inflating or deflating a packer with borehole fluid.

It will be understood from the foregoing description that various modifications and changes may be made in the preferred and alternative embodiments of the present invention without departing from its true spirit.

This description is intended for purposes of illustration only and should not be construed in a limiting sense. The scope of this invention should be determined only by the language of the claims that follow. The term “comprising” within the claims is intended to mean “including at least” such that the recited listing of elements in a claim are an open group. “A,” “an” and other singular terms are intended to include the plural forms thereof unless specifically excluded.

What is claimed is:

1. A pumping system for a downhole tool positionable in a wellbore penetrating a subterranean formation, comprising:
an actuator having a body slidably positionable in a vessel, the body defining a first chamber and a second chamber in the vessel;
a fluid movement source having at least one port for selectively moving fluid in at least two directions; and
a passive flow distribution block adapted to selectively divert fluid from the fluid movement source to one of the first and second chambers whereby the body is selectively reciprocated.

2. The pumping system of claim 1, wherein the fluid movement source is directing fluid in a first direction such that the pressure at one port of the fluid movement source is lower than the pressure at another port of the fluid movement source, and wherein the passive flow distribution block includes a check valve and a reservoir with the check valve permitting fluid movement from the reservoir to the port of the fluid movement source having the lower pressure.

3. The pumping system of claim 2, wherein the passive flow distribution block includes a check valve positioned between the reservoir and the port having the higher pressure so as to block the flow of fluid from the port having the higher pressure to the reservoir.

4. The pumping system of claim 2, wherein the passive flow distribution block further comprises a pilot check valve positioned between the reservoir and the second chamber of the actuator to permit fluid to flow from the second chamber of the actuator to the reservoir.

5. The pumping system of claim 4, wherein the passive flow distribution block further comprises another pilot check valve positioned between the reservoir and the first chamber of the actuator to prevent fluid from flowing from the first chamber of the actuator to the reservoir.

6. The pumping system of claim 2, wherein the passive flow distribution block further comprises a check valve positioned between the reservoir and the actuator to prevent fluid from flowing from one chamber of the actuator to the reservoir.

7. The pumping system of claim 2, wherein the passive flow distribution block further comprises an inverse shuttle valve positioned in parallel with the actuator.

8. The pumping system of claim 1, wherein the fluid movement source includes a bi-directional pump.

9. The pumping system of claim 8, wherein the bi-directional pump includes two different single direction pumps, and a motor driving the two different single direction pumps.

10. The down hole tool pumping system of claim 8, wherein the bi-directional pump includes two separate motors with each motor driving respective single direction pumps.

11. A down hole tool positionable in a well bore having a wall and penetrating a subterranean formation, the formation having a fluid therein, the down hole tool comprising:
a housing; and
a pumping system, comprising:
an actuator having a body slidably positionable in a vessel, the body defining a first chamber and a second chamber in the vessel;
a fluid movement source having at least one port for selectively moving fluid in at least two directions; and
a passive flow distribution block adapted to selectively divert fluid from the fluid movement source to one of the first and second chambers whereby the body is selectively reciprocated.

12. The downhole tool of claim 11, wherein the fluid movement source is directing fluid in a first direction such that the pressure at one port of the fluid movement source is lower than the pressure at another port of the fluid movement source, and wherein the passive flow distribution block includes a check valve and a reservoir with the check valve permitting fluid movement from the reservoir to the port having the lower pressure of the fluid movement source.

13. The downhole tool of claim 12, wherein the passive flow distribution block includes a check valve positioned between the reservoir and the port having the higher pressure so as to block the flow of fluid from the port having the higher pressure to the reservoir.

14. The downhole tool of claim 12, wherein the passive flow distribution block further comprises a pilot check valve positioned between the reservoir and the second chamber of the actuator to divert fluid from the second chamber of the actuator to the reservoir.

15. The downhole tool of claim 14, wherein the passive flow distribution block further comprises another pilot check valve positioned between the reservoir and the first chamber of the actuator to prevent fluid from flowing from the first chamber of the actuator to the reservoir.

16. The downhole tool of claim 1 2, wherein the passive flow distribution block further comprises a check valve positioned between the reservoir and the actuator to prevent fluid from flowing from one side of the actuator to the reservoir.

17. The down hole tool of claim 11, wherein the fluid movement source includes a bi-directional pump.

18. The down hole tool of claim 17, wherein the bi-directional pump includes two different single direction pumps, and a motor driving the two different single direction pumps.

19. The down hole tool of claim 17, wherein the bi-directional pump includes two separate motors with each motor driving respective single direction pumps.

20. A method for moving a body of an actuator of a downhole tool in at least two directions, the body slidably positionable in a vessel with the body defining a first chamber and a second chamber in the vessel, the downhole tool positionable in a well bore having a wall and penetrating a subterranean formation, the formation having a fluid therein, the method comprising the steps of:
actuating a fluid movement source to move fluid in a first direction through a passive flow distribution block and into the first chamber of the actuator to cause the body of the actuator to move in one direction; and
actuating the fluid movement source to move fluid in a second direction through the passive flow distribution block and into the second chamber of the actuator to cause the body of the actuator to move in another direction.
